(19) United States
(12) Patent Application Publication
(10) Pub. No.: US 2012/0178036 A1
(43) Pub. Date: Jul. 12, 2012

(54) LOW PRESSURE DEVICE FOR MELTING AND PURIFYING SILICON AND MELTING/PURIFYING/SOLIDIFYING METHOD

(75) Inventors: Jed Kraiem, Bourgoin Jallieu (FR); Roland Einhaus, Bourgoin Jallieu (FR); Hubert Lauvray, La Garenne Colombes (FR)

(73) Assignee: APOLLON SOLAR, Paris (FR)

(21) Appl. No.: 13/496,394

(22) PCT Filed: Sep. 10, 2010
(86) PCT No.: PCT/FR2010/000617

§ 371 Date: Mar. 15, 2012

(30) Foreign Application Priority Data
Sep. 15, 2009 (FR) 0904387

(51) Int. Cl. F27B 14/00; F27D 3/00

(52) U.S. Cl. 432/9; 432/156

(57) ABSTRACT

The device for melting and purifying of a silicon feedstock comprises a crucible arranged inside a sealed chamber. A thermal gradient can be applied to the crucible by an arranged heat exchanger and a heating device. The device likewise comprises a device for reducing the pressure inside the chamber to a value lower than 10⁻² mbar and a device for stirring the silicon in the crucible. The silicon feedstock successively undergoes degassing and pre-heating to atmospheric temperature, and then melting and low pressure, high temperature purification. Once the low-pressure purification step has been completed, directed crystallization is carried out.

### BACKGROUND OF THE INVENTION

The invention relates to a device for melting and purifying a silicon feedstock comprising:
a chamber,
a crucible arranged inside the chamber,
a heat exchanger arranged inside the chamber,
a heating device of the silicon feedstock inside the chamber,
an stirring device of the silicon in the crucible.

The invention also relates to a melting/purifying/solidifying method of a silicon feedstock of metallurgical origin.

### STATE OF THE ART

Metallurgical silicon is a relatively cheap silicon that, in this form, is unable to satisfy the criteria necessary for use in the photovoltaic field or in the microelectronics field. Metallurgical silicon does in fact contain too high concentrations of impurities, for example of metallic elements such as iron, aluminium, copper or titanium, which greatly impair the electric performances of the silicon (in particular in terms of feedstock carrier diffusion length). Metallurgical silicon also contains doping impurities such as for example boron and phosphorus also present in too high concentrations for use in photovoltaics or microelectronics.

Metallurgical silicon is therefore treated, more specifically purified, so that the doping impurity and non-doping impurity concentrations satisfy the minimum criteria relating to the future field of use of the silicon. This purification treatment consists, in conventional manner, of a series of technological steps aiming to specifically eliminate one or more dopants and to repeat these steps in order to lower the doping impurity concentration to below critical thresholds. However, these purification steps have the effect of very greatly increasing the cost of silicon which is linked to the final cost of photovoltaic panels.

A silicon purification channel by a gaseous method also exists which is also expensive to implement.

To ensure a constant provision of inexpensive silicon, the photovoltaic industry is developing different treatment and purification methods of silicon of metallurgical origin.

In conventional manner, a silicon purifying device comprises a chamber inside which a crucible is arranged. The metallurgical silicon feedstock is placed in the crucible in order to be melted. Once the silicon is molten, it undergoes a plurality of technological steps for the purposes of eliminating the impurities that are present.

This elimination of the impurities almost systematically comprises a solidification step of the molten feedstock. When solidification of the molten silicon takes place, segregation of the impurities to liquid phase takes place which has the effect of purifying the silicon that has just solidified. Purification by solidification is however only efficient if the impurity presents a small segregation coefficient between liquid phase and solid phase, i.e. a low ratio between the concentration in solid phase compared with the concentration in liquid phase. If the segregation coefficient is close to one, the concentration in liquid phase is slightly higher than that in solid phase, which limits the efficiency of purification by segregation. Typically, the segregation coefficient is equal to 0.8 for boron which makes this technique unsuitable for greatly reducing the boron concentration.

For this reason, other techniques are used, combined or not with a purification step by solidification/segregation. Another technique consists in placing the metallurgical silicon in a first crucible and in then melting it by means of an electron gun. Once the silicon is molten, it is reladled into a second crucible where the elements such as phosphorus are evaporated from the molten silicon bath by means of an electron gun under vacuum. Directional solidification of the silicon is then performed and the material obtained is melted again in a third crucible, at atmospheric pressure, to eliminate other impurities such as boron by means of a specific process. This new molten and purified bath is then reladled into a fourth crucible to perform a second directional solidification which will result in a silicon of photovoltaic quality. This melting/purification device is therefore particularly space consuming as it uses four different and specific crucibles at each step. It is also time consuming, energy consuming and costly as the method is divided into four specific steps which makes it fairly impractical to use.

### OBJECT OF THE INVENTION

The object of the invention is to provide a silicon purification device that is easy to implement and that performs fast and efficient elimination of the dopants and metallic impurities present in a metallurgical silicon feedstock.

The device according to the invention is characterized in that, the chamber being tightly sealed, it comprises a device for reducing the pressure inside the chamber to a value of less than 10⁻² mbar.

The method according to the invention is characterized in that it comprises:
placing the silicon feedstock in a crucible arranged inside a sealed chamber,
lowering the pressure in the chamber to a degassing pressure,
melting of the feedstock at a melting temperature, higher than the preheating temperature, in a first operating gas, at atmospheric pressure,
purifying the feedstock, at a purification pressure lower than the preheating pressure, at the melting temperature,
at least partial solidification of the feedstock, in a second operating gas, stirring of the molten feedstock being performed by the stirring device.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 schematically represents a melting/purifying device according to the invention in cross-section,

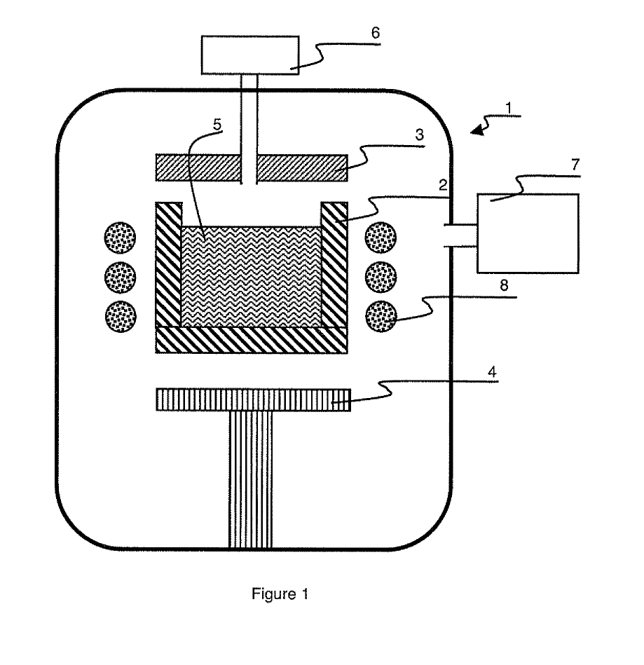

FIG. 2 schematically represents the variation of the pressure and temperature in the chamber of the device during a purification method according to the invention.

### DESCRIPTION OF A PREFERRED EMBODIMENT OF THE INVENTION

The melting/purifying device comprises a sealed chamber 1 inside which a crucible 2 is arranged. Crucible 2 is arranged between a heating device 3 and a heat exchanger 4. Heating device 3 and heat exchanger 4 define a thermal gradient in crucible 2 and therefore in a silicon feedstock 5 placed inside the crucible. Feedstock 5 can also be formed by a silicon alloy, for example silicon-germanium alloys, but it contains a majority of silicon.

Crucible 2 is for example made from graphite, quartz, or silica. Crucible 2 can be protected by an internal deposition which forms a protective layer and/or a non-adhesive layer (not shown). This internal deposition can be formed by a layer of silicon nitride, silicon dioxide, silicon oxynitride, a stack of the latter. Crucible 2 is advantageously a reusable crucible.

Heating device 3 is for example a resistive heating device, typically a heated susceptor. It can also be envisaged to have heating of the feedstock by means of an induction device. Heat exchanger 4 enables heat to be removed from the crucible. Heat exchanger 4 is for example a water heat exchanger or a support device of crucible 2 that is cooled. The thermal gradient applied in crucible 2 is advantageously perpendicular to the bottom of crucible 2 during the melting phase of silicon feedstock 5 and especially during the solidification phase of the molten silicon. The thermal gradient perpendicular to the bottom of the crucible is defined between the heating resistance placed above the crucible and heat exchanger 4 arranged adjacent to the bottom of the crucible. Heating device 3 can comprise an additional heating element which is located under the crucible, for example in proximity to heat exchanger 4.

Heating device 3 can comprise an operating gas inlet opening connected to an input device 6 of at least one operating gas. This gas can also be a gaseous mixture. The operating gas can be used at reduced pressure or at atmospheric pressure. The gas inlet opening is advantageously arranged in the centre of heating device 3 above the crucible, i.e. along the axis of symmetry of heating device 3 and crucible 2. Input device 6 can input different gases to the chamber either simultaneously or with a time stagger according to the operating conditions. The operating gas or gaseous mixture is advantageously of inert type such as argon or an argon-based mixture.

Crucible 2 is advantageously thermally insulated on its side walls so as to encourage the existence of a completely vertical thermal gradient.

Crucible 2 is filled by a silicon feedstock 5, for example by a feedstock of metallurgical-quality silicon. Crucible 2 can be fed with the silicon feedstock by means of a feed device that is not represented. The crucible can thus be fed even after melting of a first feedstock batch.

The melting/purifying device comprises a device 7 for reducing the pressure inside sealed chamber 1 to a value of less than 10⁻² mbar. This device for applying a reduced pressure comprises a pumping device of the atmosphere in chamber 1. The pumping device comprises for example a vane pump, a turbo-molecular pump, or a roots pump, and a diffusion pump in order to modulate the pressure in the chamber from atmospheric pressure to a pressure for example of about 10⁻⁵ mbar or less.

The vane pump is a pump called dry pump that enables a primary vacuum to be obtained. The turbo-molecular pump or roots pump enables the negative pressure to be stabilized around a value equal to 10⁻² mbar. An oil diffusion pump is then used to reduce the pressure in the chamber to a value comprised between 10⁻⁴ and 10⁻⁵ mbar.

The pumping device is formed by any suitable means, i.e. by any type of pump capable of making the pressure in chamber 1 vary between atmospheric pressure and a pressure of about 10⁻² mbar and more particularly between atmospheric pressure and a pressure of about 10⁻⁴ to 10⁻⁵ mbar. In conventional manner, the pumps are equipped with valves which enable switching to be performed from one pump system to another pump system. Device 7 for reducing the pressure inside chamber 1 also comprises trapping devices which recover and condensate certain vapors originating from chamber 1, for example vapors originating from crucible 2.

The melting/purifying device also comprises a stirring device 8 of feedstock 5 in liquid state enabling the molten silicon to be stirred in crucible 2 thereby renewing the top surface of the molten silicon bath. Stirring device 8 is for example of electromagnetic stirring type or of the type performing gas injection into the liquid/bubbling of the liquid, here bubbling in the molten silicon feedstock.

If stirring device 8 is of electromagnetic type, this stirring device is advantageously arranged in proximity to crucible 2, preferably laterally offset with respect to crucible 2. Typically, stirring device 8 is located adjacent to the side walls of crucible 2. The inductors of electromagnetic stirring device 8 are arranged on two opposite side walls of crucible 2 or on all the side walls of crucible 1. The stirring device can also be formed by an inductor arranged all around the crucible in the form of a spiral. To enhance stirring in the molten silicon, stirring device 8 has a variable current having a frequency comprised between 50 Hz and 100 kHz flowing through it, typically a sine-wave or square current. The inductor of the stirring device is advantageously located in the chamber whereas the frequency generator can be positioned indifferently inside or outside the chamber.

If stirring device 8 is of electromagnetic induction type, it is advantageous to use the field induced in the volume of the already molten feedstock to at least partially perform heating of the latter. Stirring device 8 is then a complementary element of heating device 3.

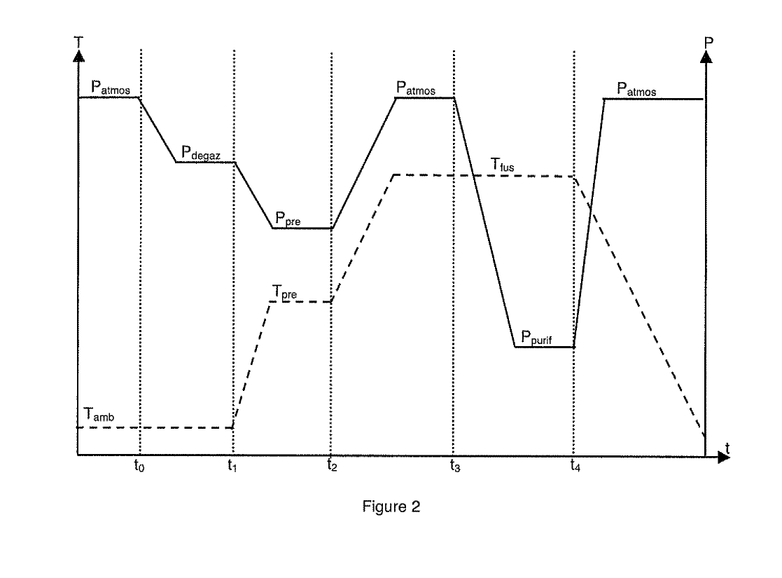

The melting/purifying device can be used according to the following method. Silicon feedstock 5, preferably of metallurgical grade, is placed in crucible 2 and the assembly is loaded into sealed chamber 1 which is at atmospheric pressure Pₐₜₘₒₛ. The schematic variation of the pressure and temperature in the chamber is illustrated in FIG. 2.

From a time t₀, device 7 for reducing the pressure inside chamber 1 then performs lowering of the pressure from atmospheric pressure Pₐₜₘₒₛ to a degassing pressure P_{degas} which is comprised between atmospheric pressure and a pressure of about 10⁻² mbar, advantageously equal to or about 10⁻² mbar, which is the best trade-off between ease of obtaining the required pressure and efficiency of degassing. For example, a first pump of device 7, here the vane pump, then creates a primary vacuum in chamber 1. When degassing pressure P_{degas} is established, crucible 1 and silicon feedstock 5 degas. For example, the temperature in the chamber is substantially equal to ambient temperature T_{amb}, but heating can have already begun and the temperature is therefore higher than the ambient temperature. Heating during degassing can be performed directly after the feedstock has been placed in order to reach purification temperature T_{purif} or preheating temperature Tₚᵣₑ more quickly.

In an optional preheating step, from a time t₁, silicon feedstock 5 is heated to reach a preheating temperature Tₚᵣₑ, for example 900° C. This preheating temperature Tₚᵣₑ is obtained using heating device 3. During the temperature rise or once preheating temperature Tₚᵣₑ has been reached, the pressure in the chamber is lowered to preheating pressure Pₚᵣₑ by means of device 7 for reducing the pressure inside chamber 1. Preheating pressure Pₚᵣₑ is lower than degassing pressure P_{degas}. Preheating pressure Pₚᵣₑ is typically about 10⁻² mbar or less.

For example purposes, a second pump, here the turbo-molecular pump, can be used to reach preheating pressure Pₚᵣₑ. During these first two phases of the method, it is not necessary to inlet an operating gas or a gaseous mixture to chamber 1.

In a third step, from a time t₂, the temperature in chamber 1 increases to reach a melting temperature Tₘₑₗₜ of feedstock 5. Melting temperature Tₘₑₗₜ of feedstock 5 is obtained by means of heating device 3. Once feedstock 5 has begun to melt, stirring device 8 is advantageously actuated in order to homogenize the molten material. Stirring device 8 is advantageously of electromagnetic type and is used in addition for heating the molten material bath. A first operating gas is then inlet to chamber 1 to bring the pressure back up to atmospheric pressure Pₐₜₘₒₛ. The first operating gas is advantageously a neutral gas, for example argon. The temperature in chamber 1 is stabilized at melting temperature Tₘₑₗₜ of feedstock 5 during the pressure increase. The melting temperature of silicon-based feedstock 5 is for example comprised between 1420° C. and 1500° C.

In a fourth step, from time t₃, the operating gas is stopped and the pressure drops back from atmospheric pressure Pₐₜₘₒₛ to a purification pressure P_{purif} Purification pressure P_{purif} is less than 10⁻² mbar, advantageously less than 10⁻⁴ mbar to perform efficient elimination at least of the phosphorus in the molten feedstock. In even more advantageous manner, the purification pressure is in the 10⁻⁴-10⁻⁵ mbar range which is a good practical trade-off for ease of obtaining a vacuum enabling efficient purification of the molten feedstock. This vacuum level is advantageously obtained by means of a third pump, here a diffusion pump. Purification pressure P_{purif} is typically comprised between 10⁻² and 10⁻⁵ mbar depending on the impurities or slightly lower than 10⁻⁵ mbar. The temperature in the molten material bath is also equal to melting temperature Tₘₑₗₜ. During this step, the compounds whose equilibrium vapor pressure is higher than that of silicon, for example phosphorus, aluminium or calcium, will sublimate and be absorbed in the trapping device. During this purification phase, the part of heating device 3 that is situated above crucible 2 is heated to a temperature at least equal to that in the molten bath, preferably to a temperature slightly higher than that of the molten bath to prevent condensation of the degassed impurities. During this step, the temperature in the crucible is for its part at least equal to the melting temperature, advantageously the temperature is higher than the melting temperature of the material of the feedstock to improve the efficiency of purification.

During the fourth step, the frequency of the variable current flowing in stirring device 8 is comprised between 50 Hz and 100 kHz in order to perform electromagnetic stirring in the molten material bath. This electromagnetic stirring ensures a good homogenization in the bath and accelerates evaporation of the impurities having a higher equilibrium vapor pressure than that of silicon, typically phosphorus. As the frequency of the current depends on the skin effect, the frequency varies according to the material forming crucible 2.

In a fifth step, from time t₄, the pressure reducing device is stopped and a second operating gas is inlet to chamber 1. The second operating gas can be identical to the first operating gas. The thermal gradient applied to crucible 2 varies in order to achieve solidification of the molten material in crucible 2. Electromagnetic stirring is maintained in the liquid phase that is still present in crucible 2. This stirring in the remaining material ensures homogenization of this fraction of not yet solidified material. As solidification takes place, the stirring has the effect of progressively reducing the diffusion limit layer at the interface between the liquid phase and the solid material. This results in an improved segregation of the impurities as the effective segregation coefficient at the interface between the liquid and solid phases is reduced.

In an advantageous sixth step, the last part of the feedstock which is in liquid state or which has resolidified, i.e. the part of the silicon that contains a large proportion of impurities, is eliminated by any suitable technique, for example by suction, by skimming or by cutting.

In an alternative embodiment, the device is of the metallic cold crucible oven type in which crucible 2 is made from metallic material the side walls of which are cooled. The metal crucible is divided into a plurality of sectors and each sector is cooled by a fluid, for example water. In this technology, the molten material is not in contact with the crucible on account of the magnetic forces which repel the molten material, and there is no self-crucible. The rest of the device and method are not modified.

This device groups the elements necessary for melting and purifying of a material such as metallurgical-grade silicon together in a single chamber without it being necessary to perform transfer of the material whether it be in liquid or solid state. The use of a stirring device enables the efficiency of stirring in the molten material to be increased which results in a reduction of the duration of the evaporation operation. In the case of electromagnetic stirring, this also results in a large increase of the efficiency of segregation and therefore of the productivity of the purification equipment.

This equipment enables the phosphorus concentration to be easily reduced which enables the concentration of doping impurities such as boron and phosphorus in the molten material before solidification of the latter to be controlled. Once the concentration of phosphorus atoms has been greatly reduced, it is advantageous to add doping impurities having predetermined segregation coefficients, for example gallium, in order to obtain a material comprising p-type and n-type dopant profiles that are almost parallel when solidification takes place. The material obtained is then homogeneous from the point of view of its resistivity and of its doping type.

1.-12. (canceled)

13. A device for melting and purifying a silicon feedstock comprising:
a sealed chamber,
a crucible arranged inside the chamber,
a heat exchanger arranged inside the chamber,
a heating device of the silicon feedstock inside the chamber,
an stirring device of the silicon in the crucible,
a device for reducing the pressure inside the chamber to a value lower than 10-2 mbar.

14. The device according to claim 13, wherein the stirring device is an electromagnetic induction stirring device.

15. The device according to claim 14, comprising a current generator configured to apply a variable current having a frequency comprised between 50 Hz and 100 kHz flowing through the stirring device.

16. The device according to claim 14, wherein the stirring device is arranged adjacent to side walls of the crucible.

17. The device according to claim 13, wherein the stirring device is a bubbling stirring type arranged to bubble in the silicon feedstock.

18. The device according to claim 13, wherein the heating device is a resistive heating device arranged above the crucible.

19. The device according to claim 13, wherein the crucible is made from graphite, quartz or silica.

20. The device according to claim 13, wherein the crucible is covered by a protective or non-adhesive layer such as silicon carbide, silicon nitride or silicon oxynitride.

21. The device according to claim 13, wherein the device for reducing the pressure inside the chamber comprises a molecular pump, a vane pump and a diffusion pump.

22. A melting/purifying method of a metallurgical silicon feedstock comprising successively:
placing the metallurgical silicon feedstock in a crucible arranged inside a sealed chamber,
lowering the pressure in the chamber to a degassing pressure in a degassing step,
melting the feedstock with a first operating gas at a melting temperature and at atmospheric pressure so as to form a molten feedstock, wherein the melting temperature is higher than a preheating temperature,
purifying the feedstock, at a purification pressure lower than the preheating pressure, at a temperature higher or equal to the melting temperature,
solidifying the feedstock, with a second operating gas, wherein stirring of the molten feedstock is performed.

23. The method according to claim 22, wherein the purification pressure is comprised between 10-2 and 10-5 mbar.

24. The method according to claim 22, wherein the feedstock is at ambient temperature during the degassing step.

25. The method according to claim 22, comprising heating the feedstock to a preheating temperature and at a preheating pressure wherein the preheating temperature is comprised between ambient temperature and melting temperature and preheating pressure is comprised between degassing pressure and purifying pressure.
